(19) United States
(12) Patent Application Publication
(10) Pub. No.: US 2011/0204286 A1
(43) Pub. Date: Aug. 25, 2011

(54) SYNTHETIC PHYLLOSILICATES NOT CAPABLE OF SWELLING FOR POLYMER PHYLLOSILICATE (NANO)COMPOSITES

(75) Inventors: Arno Nennemann, Bergisch-Gladbach (DE); Stefan Bahnmüller, Singapore (SG); Josef Breu, Bayreuth (DE); Michael Möller, Bayreuth (DE); Hussein Kalo, Bayreuth (DE)

(73) Assignee: BAYER MATERIAL SCIENCE AG, LAVERKUSEN (DE)

(21) Appl. No.: 13/120,871

(22) PCT Filed: Sep. 10, 2009
(86) PCT No.: PCT/EP09/06560

§ 371 Date: Apr. 26, 2011

(30) Foreign Application Priority Data
Sep. 24, 2008 (EP) 08016747.1

(51) Int. Cl. C08K 3/34; C09K 3/00

(52) U.S. Cl. 252/182.33; 252/182.32; 252/182.35; 524/443

(57) ABSTRACT

The present invention relates to a process for the production of non-swellable phyllosilicate tactoids, comprising
A) producing a synthetic smectite of the formula I in a high-temperature-melt synthesis

[M_{n/Valenz}]^{inter}[M^{I}ₘM^{II}ₒ]^{oct} [M^{III}₄]^{tet} X₁₀Y₂ (I)
B) if the interlayer cation M does not already have a hydration enthalpy from −6282 to −406 [kJ/mol], exchanging the interlayer cation M with a cation having a hydration enthalpy from −6282 to −406 [kJ/mol] by a cation-exchange method,
C) dispersing phyllosilicate in an aqueous system, and
D) exchanging M with a cation having a hydration enthalpy from −405 to 0 [kJ/mol], by a cation-exchange method.

The present invention relates to novel non-swellable phyllosilicate tactoids, and also to a process for their production, and to the use in polymer materials.

Phyllosilicates are used for the production of polymer nanocomposites which, when compared with the unfilled polymers, have properties improved for example with respect to mechanical or barrier characteristics.

In order to introduce phyllosilicates into polymeric materials, a general precondition in the literature is the use of long-chain ammonium or phosphonium ions for intercallation in the inter-layer space of phyllosilicates. The result of this is hydrophobization, i.e. compatibilization with respect to the organic matrix, and also layer separation. The latter layer separation is required in order to facilitate introduction into polymers which are intended to pass into the inter-layer space and give in-situ exfoliation, i.e. the maximum possible extent of cleavage to give individual silicate layers or tactoids, and thus homogeneous dispersion in the matrix. The aspect-ratio increase brought about by the exfoliation is considered (H. A. Stretz, D. R. Paul, R. Li, H. Keskkula, P. E. Cassidy, Polymer 2005, 46 2621-2637) to be a significant condition for the production of polymer-phyllosilicate nanocomposites with improved properties. For explanation of the terms exfoliation and delamination, reference is made to G. Lagaly, J. E. F. C. Gardolinsky, Clay Miner. 2005, 547-556. Examples of intercalatable and exfoliatable phyllosilicates are montmorillonites or hectorites, from the smectites group.

A disadvantage in the use of long-chain ammonium or phosphonium ions for modifying the phyllosilicates is the production of ordered intercalated structures (G. Lagaly, Solid State Ionics 1986, 22 43-51). The layers of the silicates here are flat and parallel, and held together by way of hydrophobic and van der Waals interactions, with wide lateral extension. The polymeric substrate materials would have to pass into the highly ordered inter-layer space, and to this end would have to undergo a disentanglement and stretching process, and would have to overcome attractive interactions with the modifiers in order to penetrate deeply into the said ordered inter-layer structure (E. Ruitz-Hitzky, A. van Meerbeek, in Handbook of Clay Science Eds.: F. Bergaya, B. K. G. Theng, G. Lagaly, Elsevier, Amsterdam 2006, p. pp. 583-621, F. Gardebien, A. Gaudel-Siri, J. L. Bredas, R. Lazzaroni, J. Phys. Chem. B 2004, 108 10678-10686). A disentanglement and stretching process is entropically disadvantageous, and penetration is slowed by the attractive interactions. This intercalation of the polymer chains into the inter-layer space provided by separation of the layers achieves only a low level of coupling of the margins of the phyllosilicate tactoids to the polymeric matrix. Furthermore, a large amount of modifier is required for the modification of phyllosilicates (J. W. Jordan, J. Phys. Chem. 1949, 53 294-306), since it has not been possible hitherto to differentiate between the interior surface (=inter-layer space) and the exterior interface.

The synthesis of phyllosilicates is described in J. T. Kloprogge, S. Komarneni, J. E. Amonette, Clays Clay Miner. 1999, 47529-554. Synthetic phyllosilicates have hitherto been used in a manner analogous to that for naturally occurring phyllosilicates, i.e. they are likewise modified by using long-chain ammonium or phosphonium ions, so that they can then be converted to intercalated nanocomposites, or to nanocomposites having a maximum degree of exfoliation (L. T. J. Korley, S. M. Liff, N. Kumar, G. H. McKinley, P. T. Hammond, Macromolecules 2006, 39 7030-7036). There has been no disclosure of targeted conversion of swellable to non-swellable tactoids (layer stacks) for use in polymer composites. The generally held opinion is that substantial exfoliation is required for improving composite properties. The said exfoliation generally takes place in situ via chemical or physicomechanical process during processing.

Traditional fillers, such as talc or mica, are likewise phyllosilicates, but these are not capable of intercalation, except possibly under extreme conditions, and are not capable of exfoliation (K. Tamura, S. Yokoyama, C. S. Pascua, H. Yamada, Chem. Mater. 2008, 20 2242-2246). If these are used as composite materials, properties are markedly poorer than when swellable phyllosilicates are used, examples being montmorillonites, which give intercalated or exfoliated/partially exfoliated nanocomposites. Talc or mica gives traditional composites with poor coupling and dispersion of the filler. The result of this is non-transparent materials having comparatively poor mechanical properties.

A synthesis process for smectites in a closed crucible system is described in J. Breu, W. Seidl, A. J. Stoll, K. G. Lange, T. U. Probst, Chem. Mater. 2001, 13 4213-4220. The relatively high process temperatures and the need for high-purity, dry starting materials are disadvantages of the said process.

EP 0326019A2 describes the partially synthetic preparation of swellable and non-swellable micas. This process uses existing, natural phyllosilicates (talc or the like) and silicon fluorides of the formula M₂SiF₆ as starting materials. JP002000247630AA and JP002000247629AA describe the partially synthetic preparation of phyllosilicates by way of an aqueous intermediate stage. JP000011199222AA and other references describe the partially synthetic preparation of phyllosilicates at temperatures above 1400° C., using exclusively Mg²⁺ for the octahedral layer. The said applications do not describe the process of the invention, based on the use of an amorphous glass and of simple, inorganic compounds, such as silica, binary fluorides, carbonates and/or oxides as precursor's.

DE000069521136T2 and other references describe the hydrothermal synthesis of smectites from an aqueous reaction mixture. There is no description of high-temperature-melt synthesis. It is well known that the tactoid sizes of smectites of hydrothermal and melt-synthetic origin vary markedly. According to the invention, phyllosilicate tactoids having high aspect ratios are advantageous. Hydrothermal synthesis of Na hectorite, by way of example, delivers only tactoids of size from 20 to 80 nm (particle size determined from transmission electron micrographs). Additional factors militating against the use of hydrothermal syntheses are that the reaction times are long, from a few days to weeks, and that the pressures for industrial process are high.

Starting from the prior art, an object was then to provide phyllosilicates which no longer require modification of the interlayers by using long-chain ammonium or phosphonium ions, and exfoliation for incorporation into polymer (nano)composites.

Surprisingly, it has now been found that synthetic phyllosilicates in the form of non-swellable, rigid tactoids (“layer stacks”) could be converted to polymer composites with markedly improved properties, without any requirement for interlayer modification or any requirement to obtain exfoliated structures. Furthermore, it was possible to achieve selective organophilization of the exterior surfaces of the tactoids. In comparison to conventional organophilization, this step required only a fraction of the amount of the modifier, since no loading occurs in the inter-layer spaces. Since the step of exfoliation in situ of the organophilized phyllosilicate was omitted, the selection of the cationic organic modifier could be more flexible. It was now possible to omit relatively-long-chain “alkyl spacers”, and concentrate on matching surface tensions, to achieve the best possible interaction with the polymer matrix.

This was rendered possible by the use of specifically synthesized phyllosilicates with clearly defined swell properties and with large theoretical aspect ratios. Using the process described, it is possible to achieve, as a function of stoichiometry and process parameters, average tactoid sizes from 1 μm to 300 μm (tactoid sizes determined by way of scanning electron micrographs). In contrast to this, hydrothermal synthesis of Na hectorite by way of example gives only tactoids of size from 20 to 80 nm (tactoid sizes determined by way of transmission electron micrographs). Natural montmorillonites by way of example are of the order of size of up to about 400 nm (tactoid sizes determined by way of transmission electron micrographs). Although mica can form tactoids in the cm range, its use in materials science is restricted by its severely limited intracrystalline reactivity. When compared with synthesis processes described previously for smectites in a closed crucible system, a process of the invention exhibited marked advantages over synthesis in a closed crucible system by virtue of energy-efficient heating by use of high-frequency induction, the use of low-cost starting compounds (no requirement for high purity level, no requirement for predrying of the starting materials, wider range of starting materials, e.g. advantageous carbonates) and greatly reduced synthesis time, and also the possibility for repeat use of the crucible.

The invention provides a process for the production of non-swellable phyllosilicate tactoids, by
A) producing synthetic smectites of the formula [M_{n/Valenz}]^{inter} [M^{I}ₘ M^{II}ₒ]^{oct} [M^{III}₄]^{tet} X₁₀ Y₂ by way of high-temperature-melt synthesis, where
   M are metal cations having oxidation state from 1 to 3
   M^{I.} are metal cations having oxidation state 2 or 3, preferably Mg, Al, or Fe
   M^{II} are metal cations having oxidation state 1 or 2
   M^{III} are atoms having oxidation state 4
   X are dianions
   Y are monoanions
   m≦2.0 for metal atoms M^{I} having the oxidation state 3; ≦3.0 for metal atoms M^{I} having the oxidation state 2
   o≦1.0
   layer charge n=from 0.2 to 0.8
B) if the interlayer cation M does not already have a hydration enthalpy of from −6282 to −406 [kJ/mol], preferably from −4665 to −1360 [kJ/mol], it is exchanged with a cation of this type by a cation-exchange method and the phyllosilicate is dispersed in an aqueous system

C) M is then exchanged with a cation having hydration enthalpy of from −405 to 0 [kJ/mol], preferably from −322 to −277 [kJ/mol], by a cation-exchange method, and
D) if appropriate, cationic compounds, ionic and non-ionic surfactants, or, respectively, amphiphilic compounds, metal compounds, polyelectrolytes, polymers, or precursors of these, or silanes, are finally used for full or partial loading of the exterior surfaces.

The invention further provides non-swellable phyllosilicate tactoids thus obtainable, and also their use in polymer composites.

It is preferable that M has the oxidation state 1 or 2. It is particularly preferable that M is Li⁺, Na⁺, Mg²⁺, or a mixture of two or more of these ions.

M^{I} is preferably Mg²⁺, Al³⁺, Fe²⁺, Fe³⁺ or a mixture of two or more of these ions.

M^{II} is preferably Li⁺, Mg²⁺ or a mixture of these cations.

M^{III} is preferably a tetravalent silicon cation.

X is preferably O²⁻.

Y is preferably OH⁻ or F⁻, particularly preferably F⁻.

The layer charge n is preferably from 0.35 to 0.65.

Synthetic smectites in A) of the formula [M_{n/valency}]^{inter} [M^{I}ₘM^{II}ₒ]^{oct} [M^{III}₄]^{tet} X₁₀Y₂ are produced by heating compounds of the desired metals (salts, oxides, glasses) in a stoichiometric ratio in an open or closed crucible system to give the homogeneous melt, and then cooling.

In the case of synthesis in the closed crucible system, the starting compounds used comprise alkali metal salts/alkaline earth metal salts, alkaline earth metal oxides and silicon oxides, preferably binary alkali metal fluorides/alkaline earth metal fluorides, alkaline earth metal oxides and silicon oxides, particularly preferably LiF, NaF, KF, MgF₂, MgO, quartz.

The quantitative proportions of the starting compounds are from 0.4 to 0.6 mol of F⁻ in the form of the alkali metal/alkaline earth metal fluorides per mole of silicon dioxide and from 0.4 to 0.6 mol of alkaline earth metal oxide per mole of silicon dioxide, preferably from 0.45 to 0.55 mol of F⁻ in the form of the alkali metal/alkaline earth metal fluorides per mole of silicon dioxide and from 0.45 to 0.55 mol of alkaline earth metal oxide per mole of silicon dioxide, particularly preferably from 0.5 mol of F⁻ in the form of the alkali metal/alkaline earth metal fluorides per mole of silicon dioxide and 0.5 mol of alkaline earth metal oxide per mole of silicon dioxide.

The method of supplying materials to the crucible is preferably that the more volatile substances are first weighed in, and are followed by the alkaline earth metal oxide and finally silicon oxide. Typically, a crucible composed of high-melting-point material is used, made of chemically inert or low-reactivity metal, preferably molybdenum or platinum.

It is preferable that the crucible supplied with material, and still open, is baked in vacuo at temperatures of from 200° C. to 1100° C., preferably from 400 to 900° C., prior to sealing, in order to remove residual water and volatile contaminants. The preferred experimental procedure is that the upper edge of the crucible is red-hot, while the lower region of the crucible is at lower temperatures.

A presynthesis is optionally carried out in the sealed pressure-tight crucible for from 5 to 20 min at from 1700 to 1900° C., particularly preferably at from 1750 to 1850° C., in order to homogenize the reaction mixture.

The baking process, and also the presynthesis, is typically carried out in a high-frequency induction furnace. The crucible is protected here from oxidation by an inert atmosphere (e.g. argon), or reduced pressure, or a combination.

The main synthesis process is carried out using a temperature ramp appropriate for the material. This step is preferably carried out in a rotary graphite kiln with horizontal orientation of the axis of rotation. In the first heating step, the temperature is increased from RT to from 1600 to 1900° C., preferably to from 1700 to 1800° C., using a heating rate of from 1 to 50° C./min, preferably from 10 to 20° C./min. In the second step, the system is heated at from 1600 to 1900° C., preferably at from 1700 to 1800° C. The heating phase of the second stage preferably takes from 10 to 240 min, particularly preferably from 30 to 120 min. In the third step, the temperature is lowered to a value of from 1100 to 1500° C., preferably from 1200 to 1400° C., using a cooling rate of from 10 to 100° C./min, preferably from 30 to 80° C./min. In a fourth step, the temperature is lowered at a cooling rate of from 0.5 to 30° C./min, preferably from 1 to 20° C./min, to a value of from 1200 to 900° C., preferably from 1100 to 1000° C. After the fourth step, the reduction of the temperature to room temperature takes place at from 0.1 to 100° C./min, or preferably in uncontrolled fashion, by switching off the furnace.

Operations typically take place under inert gas, e.g. Ar or N₂.

The crucible is broken open to give the phyllosilicate in the form of a crystalline, hygroscopic solid.

In the case of synthesis in the open crucible system, in a first step a glass intermediate of general composition wSiO₂.xM^{a}.yM^{b}.zM^{c} is prepared, where w,x,y,z are oxidic constituents whose quantities are independent of one another, within the glass,

preferably where 5<w<7; 0<x<4; 0≦y<2; 0≦z<1.5
particularly preferably where w=6, x=1, y=1, z=0.

M^{a}, M^{b}, M^{c} can, independently of one another, be metal oxides, preferably Li₂O, Na₂O, K₂O, Rb₂O, MgO, particularly preferably Li₂O, Na₂O, MgO. M^{a}, M^{b} and M^{c} are not identical.

The glass is prepared with the desired stoichiometry from the desired salts, preferably from the carbonates, particularly preferably Li₂CO₃, Na₂CO₃, and from a silicon source, e.g. silicon oxides, preferably silica. The pulverulent constituents are converted to a glassy state via heating and rapid cooling. It is preferable that the conversion is carried out from 900 to 1500° C., particularly at from 1000 to 1300° C. The heating phase for the production of the glass intermediate takes from 10 to 360 min, preferably from 30 to 120 min, particularly preferably from 40 to 90 min. This procedure is typically carried out in a glassy carbon crucible under an inert atmosphere or at reduced pressure by means of high-frequency induction heating. The reduction of the temperature to RT takes place by switching off the furnace. The resultant glass intermediate is finely ground, e.g. by means of a powder mill.

Further reactants are added to the glass intermediate in a ratio by weight of from 10:1 to 1:10, in order to achieve the stoichiometry in A). Preference is given to ratios of from 5:1 to 1:5. An excess of the volatile additives of up to 10% can be added, if necessary.

Examples of the said reactants are alkali metal compounds or alkaline earth metal compounds and/or silicon compounds, and preference is given to the use of fluorides of light alkali metals and/or of light alkaline earth metals, and also the carbonates or oxides of these, and also to silicon oxides, and particularly to the use of NaF, MgF₂, LiF and/or a calcined mixture made of MgCO₃Mg(OH)₂ and silica.

The mixture is then heated above the inciting point of the eutectic of the compounds used, preferably from 900 to 1500° C., particularly preferably from 1100 to 1400° C. The heating phase preferably takes from 1 to 240 min, particularly preferably from 5 to 30 min. The heating is to be carried out at from 50 to 500° C./min, preferably at the maximum possible heating rate of the furnace. The reduction of the temperature to room temperature after the heating phase takes place at from 1 to 500° C./min, and preferably in uncontrolled fashion by switching off the furnace. The product is obtained in the form of crystalline, hygroscopic solid.

The synthesis is typically carried out in a glassy carbon crucible under an inert atmosphere. The typical method of heating is high-frequency induction.

This process described is substantially more cost-effective than the synthesis in a closed crucible system, by virtue of energy-efficient heating by use of high-frequency induction; the use of low-cost starting compounds (no requirement for high purity level, no requirement for predrying of the starting materials, wider range of starting materials, e.g. advantageous carbonates) and greatly reduced synthesis time, and also the possibility for repeat use of the crucible.

If cation exchange is required in B), this can be carried out according to K. A. Carrado, A. Decarreau, S. Petit, F. Bergaya, G. Lagaly, in Handbook of Clay Science Eds.: F. Bergaya, B. K. G. Theng, G. Lagaly), Elsevier Ltd., Amsterdam 2006, pp. 115-139.

The conduct of the process is preferably such that the intermediate-layer cations having the abovementioned enthalpy of hydration essential to the invention are not introduced before the synthesis in A) is complete, but instead are introduced via cation exchange. The synthetic smectite from A) is mixed for this purpose with an excess of salt solution of a water-soluble salt comprising the cation essential to the invention, with shaking, and washed with deionized water until free from anions. This washing step is preferably repeated a number of times. The suspension is then dispersed, in order to establish the desired degree of exfoliation of the tactoids. Dispersion takes place physically by means of rotor-stator disperser, ball mill, ultrasound, high-pressure-jet dispersion (e.g. microfluidizer), or by way of thermal expansion (“popcorn effect”). The dispersion preferably takes place by means of high-pressure-jet dispersion (e.g. microfluidizer).

Intermediate-layer cations according to step B) are preferably H⁺, Na⁺, Mg²⁺, Ca²⁺, Sr²⁺, Ba²⁺, Mn²⁺, Fe²⁺, Co²⁺, Ni²⁺, Zn²⁺, Gd³⁺, Fe³⁺, La³⁺, Zr⁴⁺, or Ce⁴⁺, particular preference being given to Mg²⁺, Ca²⁺, or a mixture of these.

The layer separation d(001) of the synthetic smectites by virtue of the cation exchange in B) is from 14 to 33 Å, preferably from 15 to 26 Å, particularly preferably from 18 to 22 Å. The layer separation d(001) is measured on a specimen under water. Ideally, the dry phyllosilicate is slurried in an aqueous system and analysed in the form of a prepared smear in the moist state on a horizontal substrate in a powder diffractometer using Bragg-Brentano geometry.

The cation-exchange capacity in B) (determined according to G. Lagaly, F. Bergaya, L. Ammann, Clay Miner. 2005, 40 441-453) of these synthetic smectites is typically in the range 70 to 180 meq/100 g of solid, preferably 80 to 170 meq/100 g of solid, particularly preferably 90 to 160 meq/100 g of solid.

The subsequent cation exchange in C) takes place via addition of an excess of salt solution of the corresponding water-soluble salt and subsequent washing with deionized water. This step can be repeated a number of times.

Preferred intermediate-layer cations according to step C) are K⁺, Rb⁺, Cs⁺, or a mixture of these.

Without prior physical dispersion, cation-exchange capacity in C) (determined according to G. Lagaly, F. Bergaya, L. Ammann, Clay Miner. 2005, 40 441-453) of these synthetic smectites which are no longer swellable is typically 1 to 30 meq/100 g of solid, preferably less than 1 to 20 meq/100 g of solid, particularly preferably 5 to 10 meq/100 g of solid, and is prescribed solely via the exterior surfaces.

With prior physical dispersion, cation-exchange capacity in C) (determined according to G. Lagaly, F. Bergaya, L. Ammann, Clay Miner. 2005, 40 441-453) of these synthetic smectites which are no longer swellable is typically 10 to 180 meq/100 g of solid, preferably 20 to 100 meq/100 g of solid, particularly preferably 30 to 80 meq/100 g of solid, and is prescribed solely via the exterior surfaces.

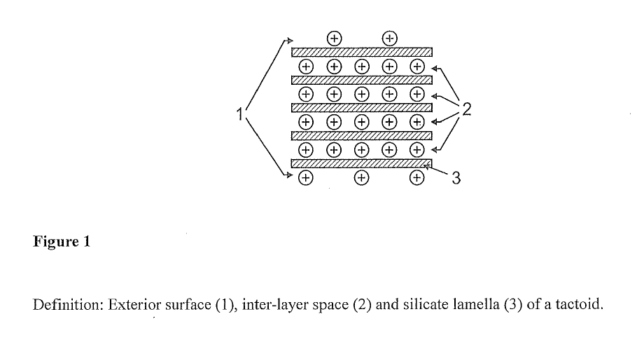

Exterior surface here denotes the upper and lower basal area of a tactoid. Inter-layer space denotes the interior of a tactoid (cf. FIG. 1).

The layer separation d(001) of the synthetic smectites in C) is<14 Å, preferably<13 Å, particularly preferably<11 Å. The layer separation d(001) is measured on a specimen under water. Ideally, the dry phyllosilicate is slurried in an aqueous system and analysed in the form of a prepared smear in the moist state on a horizontal substrate in a powder diffractometer using Bragg-Brentano geometry.

The material obtained according to step C) can be further processed in dried form or immediately according to D), preference being given here to prior drying. The drying can take place thermally, by means of spray driers or by means of freeze drying. Preference is given to spray drying and freeze drying.

The surface modification in D) preferably takes place by means of cationic compounds of the ammonium or -inium or phosphonium/inium type, or else cationic metal complexes, for the large surfaces. These cationic compounds can bear functional groups and/or can have further substitution. Silanes are preferably used for edge modification.

If cationic molecules such as ammonium or phosphonium compounds or metal complexes are used for surface modification, it is preferable to adjust the modifier to a ratio of from 0.8:1 to 4:1, particularly a ratio of from 1:1 to 1.5:1 [modifier/cation-exchange capacity of the phyllosilicate]. The value used in C) for cation-exchange capacity is the value determined according to G. Lagaly, F. Bergaya, L. Ammann, Clay Miner. 2005, 40 441-453 for the dehydrated smectites.

The surface modification in D) takes place according to the conventional procedure for the organophilization of phyllosilicates (J. W. Jordan, J. Phys. Chem. 1949, 53 294-306). The exfoliated phyllosilicate from C), which is no longer swellable, is mixed with a solution of a water-soluble salt comprising the cationic modifier, with shaking, and washed with deionized water until free from anions. This step is preferably repeated a number of times. The preferred ratio in which the modifier is used is from 0.8:1 to 4:1, particularly a ratio of from 1:1 to 1.5:1 [modifier cation/cation-exchange capacity of the phyllosilicate]. The value used in C) for cation-exchange capacity is the value determined according to G. Lagaly, F. Bergaya, L. Ammann, Clay Miner. 2005, 40 441-453 for the dehydrated smectites. When cationic polyelectrolytes are used, the ratio of cationic groups to cation-exchange capacity of the phyllosilicate is preferably adjusted to from 0.8:1 to 4:1, a particularly preferred ratio being from 1:1 to 1.5:1.

The product obtained according to step D) can be further processed in dried form or in aqueous dispersion, preference being given here to prior drying. The drying can take place thermally, by means of spray driers or by means of freeze drying. Preference is given to spray drying and freeze drying.

To produce polymer composites, phyllosilicate tactoids of the invention can be introduced into any of the familiar polymers produced via polycondensation, polyaddition, free-radical polymerization, ionic polymerization and copolymerization. Examples of polymers of this type are polyurethanes, polycarbonate, polyamide, PMMA, polyesters, polyolefins, rubber, polysiloxanes, EVOH, polylactides, polystyrene, PEO, PPO, PAN, polyepoxides.

Introduction into polymers can be achieved by means of familiar techniques, e.g. extrusion, kneading processes, rotor-stator processes (Dispermat, Ultra-Turrax, etc.), grinding processes (ball mill, etc.) or jet dispersion, and is a function of the viscosity of the polymers.

### EXAMPLES

X-ray analyses: Layer separation d(001) is measured on a specimen under water and, respectively, at 40% rel. humidity. Ideally, the dry phyllosilicate is slurried in an aqueous system and analysed in the form of a prepared smear in the moist state on a horizontal substrate in a powder diffractometer using Bragg-Brentano geometry. The characteristic variables were the d(001) reflection (corresponding to the layer separation), and also the full width at half maximum of the d(001) reflection of the phyllosilicate.

Cation-exchange capacity CEC: CEC was determined in accordance with G. Lagaly, F. Bergaya, L. Ammann, Clay Miner. 2005, 40 441-453.

Oxygen barrier: Oxygen barrier was determined in accordance with DIN 53380, Part 3, using measurement equipment from Modern Controls, Inc. at a temperature of 23° C., using pure oxygen. The rel. humidity of measurement gas and carrier gas was 50%. The values were standardized to 100 μm layer thickness.

Genamin S020, stearyl amine ethoxylate, Clariant Produkte (Deutschland GmbH), Sulzbach, Germany

Desmodur VP KA 8697, prepolymer, NCO content about 8.4%, viscosity about 5000 mPas (50° C.), functionality 2, molar mass 970 g/mol, Bayer MaterialScience AG, Leverkusen, DE

Desmophen® 670: slightly branched polyester containing hydroxy groups, solvent-free, having hydroxy content of 4.3%, viscosity of 3100 mPa.s (75 DEG C.) and equivalent weight of 395, Bayer MaterialScience AG, Leverkusen, DE

CPP40W corona-treated polypropylene foil from Petroplast GmbH, Am Blankenwasser 3, 41468 Neuss

Na+ cloisite; sodium montmorillonite, Southern Clay Products Inc., 1212 Church Street, Gonzales, Tex. 78629—USA, CEC 86 meq/100 g

Nanofil 757; sodium montmorillonite, Süd-Chemie AG, Moosburg, CEC 70 meq/100 g, d(001) reflection 11.7 Å (layer separation)

KCl; ≧99.5% p.a.; Carl Roth GmbH & Co. KG, Schoemperlenstr. 3-5, 76185 Karlsruhe

Li₂CO₃; >99%; Merck Eurolab GmbH, John-Deere-Str. 5, 76646 Bruchsal

Na₂CO₃; >99.5%; Sigma-Aldrich Chemie GmbH, Eschenstraβe 5; 82024 Taufkirchen

Silica (SiO₂×H₂O): >99.5%; Sigma-Aldrich Chemie GmbH, Eschenstraβe 5; 82024 Taufkirchen

MgCO₃Mg(OH)₂; extra pure; Fischer Scientific GmbH, Im Heiligen Feld 17; 58239 Schwerte

LiF; >99%; Merck Eurolab GmbH, John-Deere-Str. 5, 76646 Bruchsal

NaF; >99%; Sigma-Aldrich Chemie GmbH, Eschenstraβe 5; 82024 Taufkirchen

MgF₂; >97%; Sigma-Aldrich Chemie GmbH, Eschenstraβe 5; 82024 Taufkirchen

MgC₁₂33 6 H₂O; 99% p.a.; Grüssing GmbH, An der Bahn 4; 26849 Filsum

Quartz (SiO₂); p.a.; Merck KGaA Frankfurter Str. 250; 64293 Darmstadt (quartz is baked for 3 days at 500° C. prior to use)

NaF; Puratronic 99.995%; Alfa Aesar GmbH & Co. KG, Zeppelinstrasse 7; 76185 Karlsruhe

MgF₂; 99.9%; ChemPur, Rüppurrer Straβe 92; 76137 Karlsruhe

LiF; 99.9+%; ChemPur, Rüppurrer Straβe 92; 76137 Karlsruhe

MgO; 99.95%; Alfa Aesar GmbH & Co. KG, Zeppelinstrasse 7; 76185 Karlsruhe

Molybdenum crucibles are produced by the mechanical engineering department of Bayreuth University via erosion of solid molybdenum rods (Plansee AG, A-6600 Reutte), with diameter 2.5 cm.

Glassy carbon crucibles are purchased from HTW Hochtemperatur-Werkstoffe GmbH, Gemeindewald 41; 86672 Thierhaupten.

### Example 1a

### Production of A (Na_{0.5} hectorite, Closed Crucible System)

The Na hectorite [Na_{0.5}]^{inter} [Mg_{2.5} Li _{0.5}]^{oct} [Si₄]^{tet} O₁₀F₂ is synthesized according to a modified specification from Breu et al.^{[12]}.

The compounds NaF (99.995%; 2.624 g), MgF₂ (99.9%; 3.893 g), LiF (99.9+%; 1.621 g), MgO (99.95%; 10.076 g) and quartz (SiO₂ p.a.; 20.04 g), in the sequence mentioned, are weighed layer-by-layer into a baked high-purity molybdenum crucible in a glovebox. The crucible is heated by induction in a high vacuum while still open, until the upper edge of the crucible is red-hot. Stronger heating would drive off the more volatile fluorides in the lower part of the material. This temperature is maintained for 20 min and, in order to remove any residual water present, the vacuum is retained overnight once the heating has been switched off.

The crucible is fused so as to be gas-tight and shaken manually in order to mix the starting materials. In a pre-synthesis process, this crucible is heated uniformly by inductive heating to about 1800° C. for 10 min, in a high vacuum. After cooling, the crucible is transferred, for the main synthesis process, to a rotary graphite kiln, and heated to 1750° C. under argon within a period of 120 min. The temperature is maintained for 1 h, and the system is then cooled within a period of 8 min from 1750° C. to 1300° C. and within a period of 25 min from 1300° C. to 1050° C. After this step, the temperature is lowered to RT by switching off the furnace.

Once the crucible has been broken open, the hygroscopic phyllosilicate is obtained in the form of a colourless solid. Since the molybdenum crucible is broken open after use, it can be used only once.

Identification: d(001)=12.3 Å (at about 40% rel. humidity) 15.1 Å (under water). Full width at half maximum_{[001]} of Na hectorite=0.08° (at about 40% rel. humidity).

The washed and freeze-dried Na hectorite is a white powder with cation-exchange capacity of 97 meq/100 g. Average tactoid sizes of from 3 to 20 μm are discernible in scanning electron micrographs. (The material is prepared by applying aqueous phyllosilicate dispersions to a silicon wafer and drying, and then taking scanning electron micrographs; tactoid size is based on the diameter of the large surfaces of the primary tactoids.)

### Example 1b

### Production of A (Na_{0.6} hectorite, Open Crucible System)

The Na hectorite [Na_{0.6}]^{inter} [Mg_{2.4} Li_{0.6}]^{oct} [Si₄]^{tet} O₁₀F₂ is synthesized using an alkali glass (termed: precursor α) of composition Li₂Na₂Si₆O₁₄. This glass is produced by fine-mixing the salts Li₂CO₃ (4.90 g), Na₂CO₃ (7.03 g) and silica (SiO₂×nH₂O; 25.97 g) and inductive heating for 1 h at 1100° under argon in a glassy carbon crucible.

In parallel, a second precursor (termed: precursor β) is produced by heating MgCO₃Mg(OH)₂ (18.40 g) and silica (SiO₂×nH₂O; 18.70 g) within a period of 1 h at 900° C. in an aluminium oxide crucible in a chamber furnace.

After cooling, 17.55 g of precursor α, and also the same amount of precursor β, are pulverized and fine-mixed with 0.67 g LiF (>99%), 0.54 g NaF (>99%), and also 8.30 g MgF₂ (>97%). This mixture is then rapidly heated by induction to 1260° C. under argon in a glassy carbon crucible and left at this temperature for 15 min. After this step, the temperature is lowered to RT by switching off the furnace.

The hygroscopic phyllosilicate is obtained in the form of colourless or greyish solid.

Identification: d(001)=12.3 Å (at about 40% rel. humidity) 15.0 Å (under water). Full width at half maximum_{[001]} of Na hectorite=0.09° (at about 40% rel. humidity).

The cation-exchange capacity of the Na hectorite is 158 meq/100 g. Average tactoid sizes of from 5 to 50 μm are discernible in scanning electron micrographs. (The material is prepared by applying aqueous phyllosilicate dispersions to a silicon wafer and drying, and then taking scanning electron micrographs; tactoid size is based on the diameter of the large surfaces of the primary tactoids.)

### Example 1c

### Production of A (Na_{0.5} hectorite, Open Crucible System)

The Na hectorite [Na_{0.5}]^{inter} [Mg_{2.5}Li_{0.5}]^{oct} [Si₄]^{tet} O₁₀F₂ is synthesized according to an alkali glass (termed: precursor α) of composition Li₂Na₂Si₆O₁₄. This glass is produced by fine-mixing the salts Li₂CO₃ (4.90 g), Na₂CO₃ (7.03 g) and silica (SiO₂×nH₂O; 25.97 g) and inductive heating for 1 h at 1100° under argon in a glassy carbon crucible.

In parallel, a second precursor (termed: precursor γ) is produced by heating MgCO₃Mg(OH)₂ (19.74 g) and silica (SiO₂×nH₂O; 21.45 g) within a period of 1 h at 900° C. in an aluminium oxide crucible in a chamber furnace.

After cooling, 17.57 g of precursor α, and also the same amount of precursor γ, are pulverized and fine-mixed with 8.06 g of MgF₂ (>97%). This mixture is then rapidly heated by induction to 1325° C. under argon in a glassy carbon crucible and left at this temperature for 15 min.

Identification: d(001)=12.3 Å (at about 40% rel. humidity) 15.2 Å (under water). Full width at half maximum_{[001]} of Na hectorite=0.09° (at about 40% rel. humidity).

The cation-exchange capacity of the Na hectorite is 125 meq/100 g. Average tactoid sizes of from 5 to 30 μm are discernible in scanning electron micrographs. (The material is prepared by applying aqueous phyllosilicate dispersions to a silicon wafer and drying, and then taking scanning electron micrographs; tactoid size is based on the diameter of the large surfaces of the primary tactoids.)

In contrast to Inventive Example 1a, in the case of 1b and 1c a glass precursor α is used as main source for Li and Na. The vapour pressure of this glass is substantially smaller than the vapour pressure of the binary alkali metal fluorides, and this is an essential and prime reason for the possibility of synthesis in an open system without any major losses of substances. Since there is no need for pressure-tight sealing of the crucible, open glassy carbon crucibles of relatively large volume can, for example, be used instead of gas-tight fused molybdenum crucibles. These crucibles can be reused without difficulty.

### Example 2

### Production of B (Mg hectorite)

A 1 molar MgCl₂ solution is admixed with the Na hectorite, washed until neutral, from Inventive Example 1a, and the mixture is shaken at RT. The exchange solution is renewed twice, after centrifuging, so that the Na⁺ released is removed from the equilibrium. The exchange process is carried out until it is complete. Completeness of the exchange process can, for example, be discerned from the appearance of an integral 001 series (D. M. Moore, R. C. Reynolds, M. Duane, X-ray diffraction and the identification and analysis of clay minerals, Oxford Univ. Pr., Oxford 1997) of the Mg hectorite, or from the Na⁺ content of the aqueous supernatant liquor.

Once the material had been washed with demineralized water until free from chloride, the dispersion/exfoliation step could be carried out. To this end, an aqueous slurry of the Mg hectorite was dispersed by using 40 cycles in an M-11Y microfluidizer (nozzle variants H30Z and H10Z, in series) at from 1.1 to 1.3 kbar. Full width at half maximum_{[001]} after this exfoliation step=0.66° (for about 40% rel. humidity).

Mg hectorite: identification: d(001)=14.6 Å (at about 40% rel. humidity) 18.5 Å (under water). Full width at half maximum_{[001]}=0.07° (at about 40% rel. humidity). Cation-exchange capacity corresponds to that of the Na hectorite from Inventive Example 1.

### Example 3

### Production of C (K hectorite)

The exfoliated Mg hectorite from Inventive Example 2, predispersed using 40 cycles in the microfluidizer, is converted into the K hectorite via two exchange cycles (1.5 h or, respectively, overnight at RT) using 1 molar KCl solution. The material was washed with demineralized water until free from chloride, and then freeze-dried.

K hectorite: identification: d(001)=10.6 Å (at about 40% rel. humidity). Full width at half maximum_{[001]}=1.45°. The cation-exchange capacity of the washed and freeze-dried K hectorite is 49 meq/100 g. This corresponds to about 50% of the level of the precursor from inventive Example 2.

### Example 4a

### Production of D (_{surface}BHEDMA-_{bulk}K hectorite)

The freeze-dried K hectorite from Inventive Example 3 is slurried in a little demineralized water (about 20 g/l). To this end, a 1.2-fold excess of the modifier BHEDMA, dissolved in water, is added (the amount added, based on the cation-exchange capacity determined for the K hectorite, 49 meq/100 g, therefore being about 59 meq for 100 g of phyllosilicate), and the mixture is shaken for 5 min at 25° C. The material is freeze-dried after washing with demineralized water.

_{surface}BHEDMA-_{bulk}K hectorite: identification: d(001)=˜11.3 Å (at about 40% rel. humidity) full width at half maximum_{[001]}=2.03°.

### Example 4b

### Production of D (_{surface}Genamin S020-_{bulk}K hectorite)

The freeze-dried K hectorite from Inventive Example 3 is slurried in a little demineralized water (about 20 g/l). To this end, a 1.2-fold excess of the modifier Genamin S020 (in the form of hydrochloride), dissolved in water is added (the amount added, based on the cation-exchange capacity determined for the K hectorite, 49 meq/100 g, therefore being about 59 meq for 100 g of phyllosilicate), and the mixture is shaken for 5 min at 25° C. After washing with demineralized water, ethanol/water and ethanol, the material is dispersed in cyclohexane, from which it is freeze dried.

_{surface}Genamin S020-_{bulk}K hectorite: identification: d(001)=˜11.5 Å (at about 40% rel. humidity) full width at half maximum_{[001]}=1.99°.

### Example 5

### Production of Composite Coating with Organophilized Smectite

### Example 5a

The polyurethane precursor Desmodur VP KA 8697 is dissolved in 0.75 times the amount (by weight) of ethyl acetate. The second polyurethane precursor Desmophen 670, and also the _{surface}BHEDMA-_{bulk}K hectorite from Inventive Example 4a are dissolved separately in 1.3 times the amount (by weight) of ethyl acetate. The respective amounts are balanced in such a way that the overall ratio by weight Desmodur VP KA 8697/ Desmophen 670/_{surface}BHEDMA-_{bulk}K hectorite is 60/35/5% by weight. Once the two components have been combined and thoroughly mixed, the mixture is briefly degassed in an ultrasound bath. This mixture is doctored directly onto a substrate foil and hardened overnight at 60° C. in an oven. The substrate foil thus coated is transparent. The gas barrier value is 134 cm³/(m²dbar). The gas barrier value for the straight PP substrate foil here is 800 cm³/(m²dbar) and that of the PU-coated, silicate-free PP substrate foil is 178 cm³/(m²dbar).

### Example 5b

The method corresponds to that of Inventive Example 5a, but the _{surface}Genamin S020-_{bulk}K hectorite from Inventive Example 4b is used, instead of the _{surface}BHEDMA-_{bulk} K hectorite from Inventive Example 4a. The substrate foil thus coated is transparent and its gas barrier value is 158 cm³/(m²dbar).

### Comparative Example 1

### K-Exchanged Montmorillonite

The commercially available montmorillonite Na+ Cloisite is converted into the K⁺ form in three exchange cycles (duration: 15 min, 13 h and 5.5 h at RT) via addition of 1 molar KCl solution. The material was washed with demineralized water until free from chloride, and then freeze-dried.

Na montmorillonite, Na+ Cloisite type; identification: d(001)=12.4 Å (at about 40% rel. humidity). Full width at half maximum_{[001]}=1.2°. The cation-exchange capacity of the material is 86 meq/100 g.

K montmorillonite; identification: d(001)=11.0 Å (at about 40% rel. humidity) Full width at half maximum_{[001]}=1.3°. The washed and freeze-dried K montmorillonite has a cation-exchange capacity of 78 meq/100 g, after as little as 5 minutes of the exchange process (about 90% of original exchange capacity). A commercial, non-synthetic montmorillonite cannot be converted into non-swellable tactoids of the invention in the same manner.

### Comparative Example 2

### Production of an Organophilized Commercial Montmorillonite

The montmorillonite Nanofil 757 (sodium montmorillonite, Süd-Chemie AG, Moosburg, CEC 70 meq/100 g, d(001) reflection or layer separation value 11.7 Å) was dispersed with the aid of an Ultra-Turrax T25 (Janke+Kunkel, IKA Labortechnik) at 5% by weight in demineralized water. To this dispersion was added a solution which corresponded to 1.2 times the cation-exchange capacity of the montmorillonite, and which comprised the modifier Genamin S020 in deionized water. The 2.5% strength by weight dispersion was shaken at from 60 to 70° C. for 24 h, and then centrifuged at 3500 g. After decanting the sediment was redispersed in a 1:1 mixture made of EtOH and deionized water, washed, and again centrifuged. The washing procedure was repeated three times, and its degree of completion was checked by measuring conductivity in the supernatant liquor. The product was then freeze-dried. The loading level was 71 meq of Genamin S020/100 g (CHN analysis), corresponding to 100% of CEC, and the d(001) reflection or layer separation value was 24.6 Å.

### Comparative Example 3

### Production of Composite Coating with Organophilized Montmorillonite

The composite coating using an organophilized montmorillonite from Comparative Example 2 was prepared by analogy with Inventive Example 5b. A transparent coating on the foil was obtained, and the gas barrier value of the foil was 167 cm³/(m²dbar).

### Discussion of Properties:

The tactoid (layer stack) of the invention, made of synthetic potassium hectorite from Inventive Example 3 (stage C) exhibits a layer separation of 10.6 Å, i.e. is in the non-swellable state here, and it is virtually impossible for water of hydration to penetrate into the space between the layers. The layer separation of the swellable starting material from Inventive Example 2 is by way of example 14.6 Å, this value being brought about via the hydrated Mg inter-layer ions. Cation-exchange capacity CEC is 49 meq/100 g in Inventive Example 3, compared with 97 meq/100 g in

Inventive Example 2. This means that only about 50% of the original CEC is available for exchange by organic cations. It is primarily the exterior surfaces that become loaded, and less modifier is needed. Inventive Examples 4a and 4b provide evidence that no high level of intercalation by quaternary ammonium compounds occurs. The layer separations are 11.3 and, respectively, 11.5 Å. Bulky modifiers normally lead to layer separations>20 Å. In Comparative Example 2, a Genamin-S020-modified, commercial montmorillonite is used. The layer separation obtained here is 24.6 Å. Cation exchange takes place to the extent of 100% of the initial CEC.

Despite the relatively small amount of modifier and the non-intercalatable or -exfoliatable layers, composite coatings can be obtained with improved properties, such as an oxygen barrier, contrary to generally accepted opinion. The gas barrier value for coatings based on phyllosilicate tactoids of the invention is thus 134 cm³/(m²dbar) (composite coating Inventive Example 5a made of phyllosilicate Inv. Ex. 4a) and, respectively, 158 cm³/(m²dbar) (composite coating Inventive Example 5b made of phyllosilicate Inv. Ex. 4b), compared with 167 cm³/(m²dbar) (composite coating Comparative Example 3 made of phyllosilicate Comparative Example 2) and, respectively, 178 for the PU-coated, silicate-free PP substrate foil. Inventive Example 5a shows that a small modifier molecule, such as BHDEMA, gives better results than a familiar, long-chain layer-separating molecule such as Genamin S020. The literature produces polymer nanocomposites by using these long-chain “alkyl spacers” having onium cations (e.g. Genamin S/T/O lines using stearyl, tallow fat or oleyl moieties) which favour the exfoliation of the tactoids via widening of the separation between layers. Flexibility in surface modification is markedly greater when synthetic phyllosilicates of the invention are used.

1-9. (canceled)

10. A process for the production of non-swellable phyllosilicate tactoids, comprising
A) producing a synthetic smectite of the formula I in a high-temperature-melt synthesis
[M_{n/Valenz}]^{inter} [M^{I}ₘM^{II}ₒ]^{oct} [M^{III}₄]^{tet} X₁₀Y₂ (I)
wherein,
M represents a metal cation having an oxidation state from 1 to 3,
M^{I.} represents a metal cation having an oxidation state of 2 or 3,
M^{II} represents a metal cation having an oxidation state of 1 or 2,
M^{III} represents an atom having an oxidation state of 4,
X represents a dianion,
Y represents a monoanion,
m is less than or equal to 2.0 when the oxidation state of the meal cation is 3; or less than or equal to 3.0 when the oxidation state of the metal cation is 2,
o is less than or equal to 1.0,
n represent the layer charge and is from 0.2 to 0.8,
B) if the interlayer cation M does not already have a hydration enthalpy from −6282 to −406 [kJ/mol], exchanging the interlayer cation M with a cation having a hydration enthalpy from −6282 to −406 [kJ/mol] by a cation-exchange method and
C) dispersing phyllosilicate in an aqueous system
D) exchanging M with a cation having a hydration enthalpy from −405 to 0 [kJ/mol], by a cation-exchange method, and
E) optionally fully or partially loading an exterior surface with a compound selected from the group consisting of cationic compounds, ionic surfactants, non-ionic surfactants, amphiphilic compounds, metal compounds, polyelectrolytes, polymers, precursors of these, silanes, and mixtures thereof.

11. The process according to claim 10, wherein M^{I} represents Mg, Al, or Fe.

12. The process according to claim 10, wherein in B), if the interlayer cation M does not already have a hydration enthalpy from −4665 to −1360 [kJ/mol], exchanging the interlayer cation M with a cation having a hydration enthalpy from −4665 to −1360 [kJ/mol] in B),

13. The process according to claim 10, wherein
M represents Li⁺, Na⁺, Mg²⁺, or a mixture thereof,
M^{I} represents Mg²⁺, Al³⁺, Fe²⁺, Fe³⁺ or a mixture thereof,
M^{II} represents Li⁺, Mg²⁺ or a mixture thereof,
M^{III} represents a tetravalent silicon cation,
X represents O²⁻ and
Y represents OH⁻ or F⁻.

14. The process according to claim 10, wherein the layer charge n is from 0.35 to 0.65.

15. The process according to claim 10, wherein the smectite synthesis in A) is carried out in an open crucible system.

16. The process according to claim 15, wherein the synthetic smectite is produced using a glass intermediate of the composition wSiO₂.xM^{a}.yM^{b}.zM^{c}, wherein
w,x,y,z represents the following values: 5<w<7; 0<x<4; 0≦y<2; 0≦z<1.5,
M^{a}, M^{b}, and M^{c} represent metal oxides, wherein M^{a}, M^{b} and M^{c} are not identical.

17. The process according to claim 10, wherein a layer separation (d001) of the synthetic smectites after the cation exchange in C) is less than 14 Å.

18. A non-swellable phyllosilicate tactoid obtained by the process according to claim 10.

19. A composite material comprising the non-swellable phyllosilicate tactoid according to claim 18.

20. A composite material obtained with the non-swellable phyllosilicate tactoid according to claim 18.
